(19) United States
(12) Patent Application Publication
(10) Pub. No.: US 2014/0333881 A1
(43) Pub. Date: Nov. 13, 2014

(54) NARROW FRAME DISPLAY DEVICE AND MANUFACTURING METHOD THEREOF

(71) Applicants: BEIJING BOE DISPLAY TECHNOLOGY CO., LTD., Beijing (CN); BOE TECHNOLOGY GROUP CO., LTD., Beijing (CN)

(72) Inventors: Bo Zhou, Beijing (CN); Xiaona Liu, Beijing (CN); Yongzhi Song, Beijing (CN)

(21) Appl. No.: 14/235,975

(22) PCT Filed: Jun. 18, 2013
(86) PCT No.: PCT/CN2013/077358

§ 371 Date: Jan. 29, 2014

(30) Foreign Application Priority Data
Apr. 27, 2013 (CN) 201310153263.1

(51) Int. Cl. G02F 1/1343; G02F 1/1339

(52) U.S. Cl. CPC G02F 1/13439; G02F 1/1339
USPC 349/139; 445/25

(57) ABSTRACT

Embodiments of the present application discloses a narrow frame display device including an upper substrate, a bottom substrate, a liquid crystal layer filled between the upper substrate and the bottom substrate, and sealant disposed at peripheries of the upper substrate and the bottom substrate; the common electrodes of the display device overlapping the sealant are transparent common electrodes. A method for manufacturing the narrow frame display device is also disclosed.

### TECHNICAL FIELD

Embodiments of the present invention relate to a narrow frame display device and a manufacturing method thereof.

### BACKGROUND

Currently, narrow frame technology has been widely applied in liquid crystal displays and each manufacturer has made its own products of narrow frame. The liquid crystal displays have a larger visual area and a better display effect as the frame gets narrower.

FIGS. 1(a) and 1(b) are a front view and a partial sectional view of a conventional display panel which is not of a narrow frame design, respectively, and FIGS. 2(a) and 2(b) are a front view and a partial sectional view of an existing narrow frame display panel, respectively. It can be found by comparing FIG. 1 and FIG. 2 that, the narrow frame technology requires that sealant 1 overlaps a portion of black matrix 3 (BM) on a color filter substrate 2 and a portion of common electrode 5 on the TFT substrate 4 as well so as to reduce occupancy on peripheral area of the panel and realize a narrow frame design. The BM 3 is opaque and the common electrodes 5 are also opaque as they are made of a metal such as Cu, Al or an alloy thereof. It is difficult to cure the sealant 1 between the BM 3 and the common electrodes 5 by ultraviolet (UV) rays when the above mentioned three parts overlap each other.

In order to solve the problems mentioned above, a plurality of slits 6 parallel to each other, for example etched slits 6, are disposed on a portion of the BM 3 or a portion of the common electrode 5 that overlaps the sealant 1. UV rays can radiate on the sealant 1 through the slits such that the sealant 1 can be cured by the UV rays, as illustrated in FIGS. 3(a) and 3(b). As to the circumstance that the slits is formed on the BM 3, the UV rays radiate on the sealant 1 through the slits that are etched out on the BM 3 from the side of the color filter substrate 2 when the sealant is cured by the UV rays. As to the circumstance that the slits are etched out on the common electrodes 5, the UV rays radiate on the sealant 1 through the slits that are etched out on the common electrodes 5 from the side of the TFT substrate 4 when the sealant 1 is cured by the UV rays. However, the UV rays cannot pass through portions of the BM 3 or the common electrodes 5 other than the slits 6, consequently, the sealant 1 corresponding to the portions other than the slits 6 can not be cured completely. Thus, when intensity of the UV rays is constant, it will take more time to cure the sealant 1 by the UV rays, and the curing is done at a low efficiency.

A manufacturing process for the above TFT substrate provided with common electrodes will be briefly described as below. The process comprises the following steps. Firstly, a first transparent electrode layer is formed on the substrate, then, a gate electrode and a gate insulating layer is formed, and then, a semiconductor layer comprising source/drain electrodes and a passivation insulating layer are successively formed and a through hole is formed in the passivation insulating layer, and finally, a second transparent electrode layer is formed. It should be understood that, the common electrodes can be formed at the same time as the gate electrode as the common electrode is made of a metal such as Cu, Al or an alloy thereof, as the same as the gate electrode.

### SUMMARY

Embodiments of the present application provide a narrow frame display device and a method for manufacturing the same, in order to solve the existing problem that it will take a long time to cure sealant by the UV rays and the curing is done at a low efficiency.

According to one aspect of the present application, a narrow frame display device is provided, which comprises an upper substrate, a bottom substrate, a liquid crystal layer that is filled between the upper substrate and the bottom substrate, and sealant that is disposed at peripheries of the upper substrate and the bottom substrate, common electrodes at a position overlapping the sealant in the display device are transparent common electrodes.

For example, common electrodes at positions corresponding to each frame of the display device and overlapping the sealant are transparent common electrodes.

For example, the transparent common electrodes are made of a transparent conductive material.

For example, the transparent conductive material is indium tin oxide, indium zinc oxide or zinc oxide.

For example, the common electrodes overlapping the sealant have a thickness in a range of 400 Å to 1500 Å.

According to another aspect of the present application, a method for manufacturing a narrow frame display device is provided and comprises: disposing an upper substrate and a bottom substrate of the display device, and cell-assembling the upper substrate and the bottom substrate disposed opposing to each other to form the display device, disposing a liquid crystal layer between the upper substrate and the bottom substrate, and disposing sealant at peripheries of the upper substrate and the bottom substrate, the method further comprising forming common electrodes overlapping the sealant, and the common electrodes overlapping the sealant being made of a transparent conductive material.

For example, the common electrodes overlapping the sealant are formed simultaneously with formation of a first transparent electrode layer of the display device.

For example, the transparent conductive material of the common electrodes overlapping the sealant is the same as the material of the first transparent electrode layer.

For example, the first transparent electrode layer and the common electrodes overlapping the sealant can be formed as follows: depositing a layer of transparent conductive layer on the substrate, and forming the first transparent electrode layer and the common electrodes overlapping the sealant through a patterning process.

For example, the transparent conductive material is deposited at a temperature in a range of a room temperature to 230° C.

For example, the common electrodes overlapping the sealant and common electrodes that are not overlapping the sealant are connected to each other in a manner of lap joint.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1(a) is a front view of a conventional display panel that is not of a narrow frame design.

FIG. 1(b) is a partial sectional view of a conventional display panel that is not of a narrow frame design.

FIG. 2(a) is a front view of an existing display panel that is designed in a narrow frame manner.

FIG. 2(b) is a partial sectional view of an existing display panel that is designed in a narrow frame manner.

FIG. 3(a) is a schematic plan view of a portion of an existing color filter substrate in which slits are disposed at a portion that BM overlaps the sealant 1.

FIG. 3(b) a schematic plan view of a portion of an existing TFT substrate in which slits are disposed at a portion that common electrodes overlap the sealant 1.

FIG. 4 is a planar structure diagram of a narrow frame display panel according to an embodiment of the present application.

FIG. 5 is a partial sectional view of the narrow frame display panel according to an embodiment of the present application.

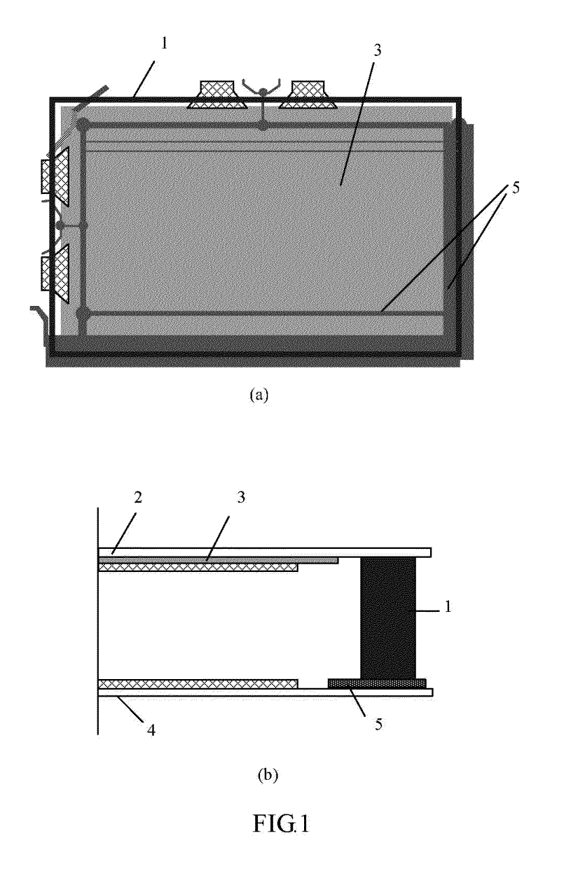

REFERENCE SIGNS
1, Sealant;
2, Color Filter Substrate;
3, Black Matrix;
4, TFT Substrate;
5, Common Electrode;
6, Slit;
51, Transparent Common Electrode

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Unless otherwise stated, technical terms or scientific terms used herein should be construed as general meanings that those skilled in the art understand. The terms “a”, “an”, “this”, “the” and the like used before an element are not limitative to the quantity thereof, and just denote the presence of at least one of such element. The terms “comprising”, “including” and the like means that the element or the thing before the terms “comprising” or “including” contains elements or things and the like listed behind the terms “comprising” or “including”, and do not exclude other elements or things. The terms “on”, “below”, “left”, “right” and the like are only intended to denote relative positional relationship of objects, and the relative positional relationship may change correspondingly if absolute positions of the described objects change.

Embodiments of the present application provide a narrow frame display device which comprises an upper substrate, a bottom substrate, a liquid crystal layer filled between the upper substrate and the bottom substrate, and sealant disposed at edges of the upper substrate and the bottom substrate. In this embodiment, common electrodes overlapping the sealant in the display device is made of transparent conductive material so as to form transparent common electrodes, so, the UV rays can radiate completely on the sealant through the common electrodes. Thus, the sealant can be cured rapidly and the curing efficiency of UV rays is improved.

The disclosure of the present application is further described in details by taking the specific embodiments as example in connection with the figures.

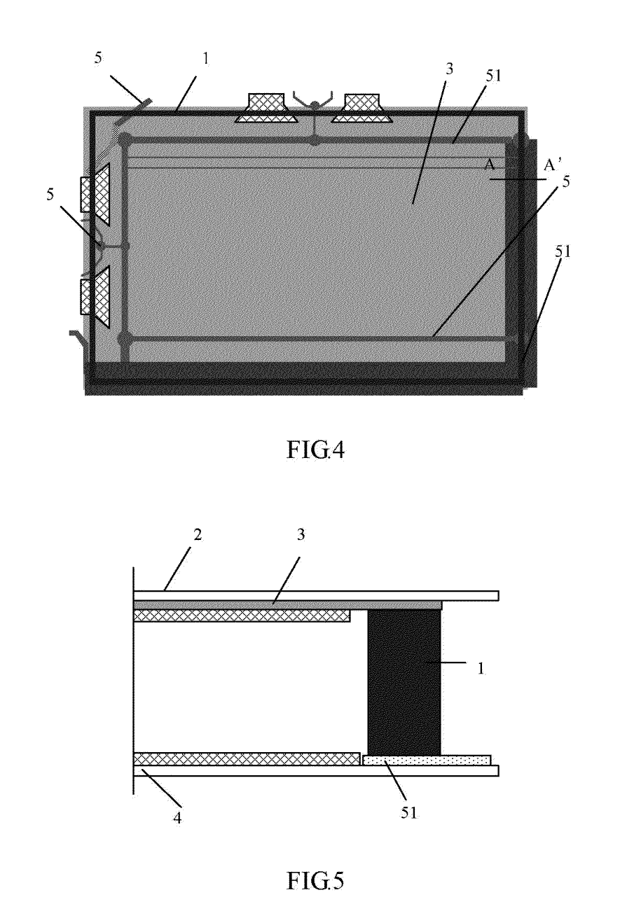

FIG. 4 is a planar structure diagram of a narrow frame display device according to an embodiment of the present application and FIG. 5 is a partial sectional view of the narrow frame display device taking along A-A′, wherein common electrodes are illustrated.

As illustrated in FIG. 4 and FIG. 5, the narrow frame display panel according to this embodiment comprises an array substrate 4, a color filter substrate 2 and sealant 1 that is disposed at periphery of the array substrate 4 and the color filter substrate 2 so as to bond the both in order to form a liquid crystal cell. Liquid crystal material is filled in the liquid crystal cell. At the periphery of the display panel, a black matrix 3 and common electrodes 51 overlap the sealant 1. The array substrate 4 and the color filter substrate 2 are examples of the upper substrate and the bottom substrate, respectively. For example, if there is a color filter structure formed on the array substrate 4 serving as the bottom substrate, the upper substrate does not comprise a color filter structure any longer.

The liquid crystal display panel can be operated in a horizontal electric field mode or in a vertical electric field mode. The horizontal electric field mode contains a Fringe Filed Switching (FFS) mode, an In-Plane Switching (IPS) mode and etc., and the vertical electric field mode contains a Twisted Nematic (TN) mode, a Vertical Alignment (VA) mode and etc..

For example, as for the FFS mode, two layers of transparent electrodes are formed for an effective display area of the array substrate, namely a common transparent electrode (Vcom) and a pixel transparent electrode, which are used for generating a horizontal electric field. As for the TN mode, two layers of transparent electrodes are also formed for the effective display area of the array substrate, namely a storage transparent electrode and a pixel transparent electrode. Besides the common electrodes in the effective display area, the array substrate further comprises common electrode wire in a non-display area (the peripheral area), which overlaps the sealant. The common electrodes in the non-display area can be connected to for example the common electrodes in the effective display area.

As illustrated in FIG. 4, the common electrodes 51 at a position overlapping the sealant 1 are made of transparent conductive material, which is selected from indium tin oxide (ITO), indium zinc oxide (IZO), zinc oxide (ZnO) and etc.. The common electrodes 51 at the position overlapping the sealant 1 are connected to the common electrodes 5 in the non-overlapping position.

As illustrated in FIG. 4, only the common electrodes 51 at corresponding positions at two adjacent frames (the right and the bottom frames) of the display device, which overlap the sealant 1, are made of a transparent conductive material. Of course, in practical applications, the common electrodes 51 at corresponding positions at the other two frames of the display device (the electrodes 51 at the left and upper frames as illustrated in FIG. 4), which overlap the sealant 1, are made of a transparent conductive material. For example, the common electrodes 51 at both the upper and the left frames of the display device as illustrated in FIG. 4, which overlap the sealant 1, are made of a transparent conductive material. The transparent common electrodes made of transparent material have a thickness in a range of 400 Å to 1500 Å. Accordingly, a portion of the black matrix 3 overlapping the sealant 1 can be provided with slits or not.

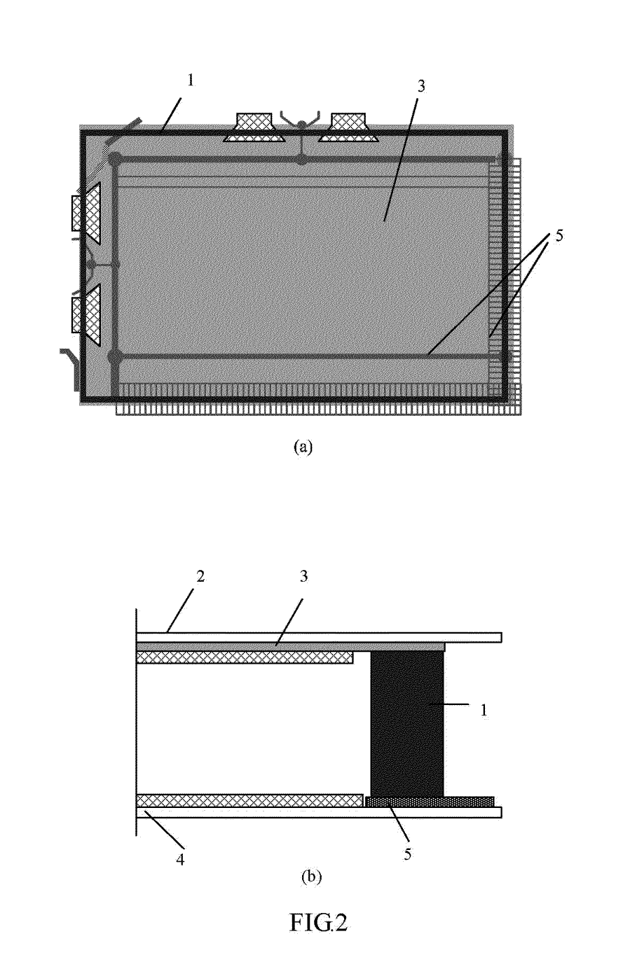

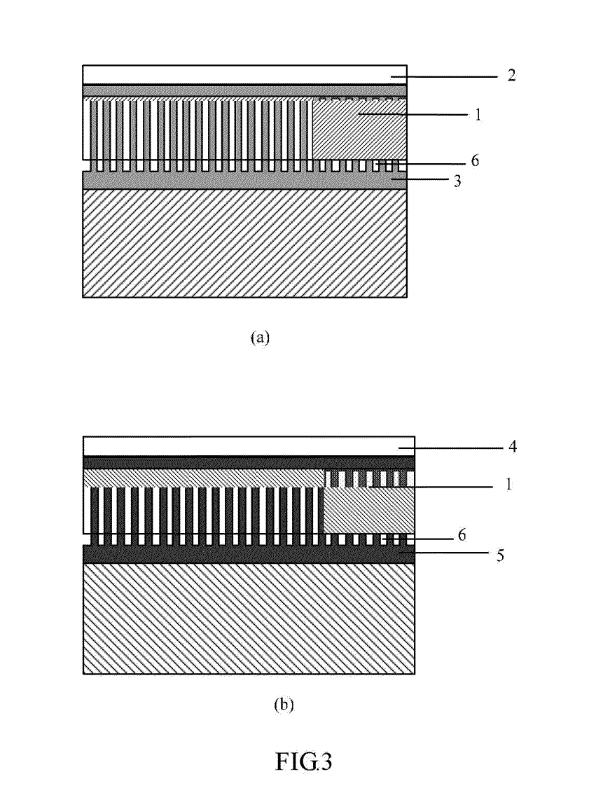

In the embodiment of the present application, as the common electrodes 51 at a position overlapping the sealant 1 are made of transparent conductive material, UV rays only need to radiate at a side of the TFT substrate 4 and the UV rays can penetrate the common electrodes 51 and radiate the sealant I when the sealant 1 is cured by the UV rays, which is different from the case as illustrated in FIG. 2, only a portion of UV rays radiating the sealant 1. Thus, according to the present embodiment, the sealant 1 can be cured rapidly and fully, and the curing efficiency is improved.

The display device according to embodiments of the present application can be of ADvanced Super Dimension Switch (ADS) type, IPS type, Plane to Line Switching (PLS) type, FFS type, TN type and etc..

A method for manufacturing a TFT substrate (the upper substrate or the bottom substrate) provided with common electrodes according to an embodiment of the present application is briefly described hereinafter. The method comprises steps 501 to 504 as below.

Step 501: A first transparent conductive electrode layer and common electrodes to overlap sealant are formed on the substrate.

As the common electrodes formed in the step is transparent, they can be made of a transparent conductive material as same as the first transparent electrode layer. Thus, the common electrodes and the first transparent electrode layer can be formed at the same time. The transparent conductive material can be ITO, IZO, ZnO or the like. Resistance of the transparent conductive material can be reduced in order to decrease electrical resistivity of the common electrodes made of the transparent conductive material. For example, deposition temperature for ITO can be reduced to realize low resistance. The deposition temperature can be reduced from 230° C. to ambient temperature (about 25° C.). As another example, transparent conductive material with lower electrical resistivity can be used. ZnO is more suitable for making the common electrodes overlapping the sealant 1 than ITO as the electrical resistivity of ZnO is lower than that of ITO.

Step 502: Continuously forming gate electrodes and common electrodes not overlapping the sealant.

Herein, the common electrodes that are not overlapping the sealant (for example, in the effective display area) are made of a metal opaque material, which is the same as the gate electrode. For example, the common electrodes that are not overlapping the sealant are connected to the common electrodes overlapping the sealant in a manner of lap joint.

Step 503: subsequently forming a gate insulating layer and forming a semiconductor layer comprising source/drain electrodes and a passivation insulating layer in sequence.

Step 504: Finally forming a through hole and a second transparent electrode layer.

Preferably, the TFT substrate can be cell-assembled with an opposed substrate (an upper substrate or a bottom substrate) such as a color filter substrate so as to form a narrow frame display device. A liquid crystal layer is disposed between the upper substrate and the bottom substrate. Sealant is disposed at peripheries of the upper substrate and the bottom substrate.

Of course, the common electrodes that are not overlapping the sealant can also be made of transparent conductive material. Under such a circumstance, the common electrodes overlapping the sealant and the common electrodes that are not overlapping the sealant can be formed simultaneously and connected to each other.

The foregoing are merely exemplary embodiments of the invention, but are not used to limit the protection scope of the invention. The protection scope of the invention shall be defined by the attached claims.

1. A narrow frame display device, comprising an upper substrate, a bottom substrate, a liquid crystal layer filled between the upper substrate and the bottom substrate, and sealant disposed at peripheries of the upper substrate and the bottom substrate; wherein
common electrodes at a position overlapping the sealant in the display device are transparent common electrodes.

2. The narrow frame display device according to claim 1, wherein common electrodes at positions corresponding to each frame of the display device and overlapping the sealant are transparent common electrodes.

3. The narrow frame display device according to claim 1, wherein the transparent common electrodes are made of a transparent conductive material.

4. The narrow frame display device according to claim 3, wherein the transparent conductive material is indium tin oxide (ITO), indium zinc oxide (IZO) or Zinc oxide (ZnO).

5. The narrow frame display device according to claim 1, wherein the common electrodes overlapping the sealant have a thickness in a range of 400 Å to 1500 Å.

6. A method for manufacturing a narrow frame display device, comprising:
disposing an upper substrate and a bottom substrate of the display device,
cell-assembling the upper substrate and the bottom substrate disposed opposing to each other to form the display device,
disposing a liquid crystal layer between the upper substrate and the bottom substrate,
disposing sealant at peripheries of the upper substrate and the bottom substrate;
wherein common electrodes overlapping the sealant are formed, the common electrodes overlapping the sealant are made of a transparent conductive material.

7. The method according claim 6, wherein the common electrodes overlapping the sealant are formed simultaneously with formation of a first transparent electrode layer of the display device.

8. The method according claim 7, wherein the common electrodes overlapping the sealant are made of a transparent conductive material which is the same as a material of the first transparent electrode layer.

9. The method according claim 7, wherein the first transparent electrode layer and the common electrodes overlapping the sealant are formed as follows:
depositing a layer of transparent conductive material on the substrate, and forming the first transparent electrode layer and the common electrodes overlapping the sealant through a patterning process.

10. The method according claim 9, wherein a deposition temperature for the transparent conductive material is in a range of a room temperature to 230°.

11. The method according to claim 6, wherein the transparent conductive material is indium tin oxide (ITO), indium zinc oxide (IZO) or Zinc oxide (ZnO).

12. The method according to claim 6, wherein the common electrodes overlapping the sealant and common electrodes that are not overlapping the sealant are connected to each other in a manner of lap joint.

13. The narrow frame display device according to claim 2, wherein the transparent common electrodes are made of a transparent conductive material.

14. The narrow frame display device according to claim 2, wherein the common electrodes overlapping the sealant have a thickness in a range of 400 Å to 1500 Å.

15. The narrow frame display device according to claim 3, wherein the common electrodes overlapping the sealant have a thickness in a range of 400 Å to 1500 Å.

16. The method according claim 8, wherein the first transparent electrode layer and the common electrodes overlapping the sealant are formed as follows:
depositing a layer of transparent conductive material on the substrate, and forming the first transparent electrode layer and the common electrodes overlapping the sealant through a patterning process.

17. The method according to claim 7, wherein the transparent conductive material is indium tin oxide (ITO), indium zinc oxide (IZO) or Zinc oxide (ZnO).

18. The method according to claim 8, wherein the transparent conductive material is indium tin oxide (ITO), indium zinc oxide (IZO) or Zinc oxide (ZnO).

19. The method according to claim 7, wherein the common electrodes overlapping the sealant and common electrodes that are not overlapping the sealant are connected to each other in a manner of lap joint.

20. The method according to claim 8, wherein the common electrodes overlapping the sealant and common electrodes that are not overlapping the sealant are connected to each other in a manner of lap joint.
